(19) United States
(12) Patent Application Publication
(10) Pub. No.: US 2002/0039484 A1
(43) Pub. Date: Apr. 4, 2002

(54) Apparatus for recording and reproducing information data

(76) Inventor: Isao Watanabe, Tokyo (JP)

Correspondence Address: COOPER & DUNHAM LLP, 1185 Avenue of the Americas, New York, NY, 10036, US

(21) Appl. No.: 09/952,168

(22) Filed: Sep. 14, 2001

(30) Foreign Application Priority Data
Sep. 18, 2000 (JP) P2000-281996

(51) Int. Cl. H04N 7/26; G11B 5/00; G11B 5/09

(52) U.S. Cl. 386/109; 386/124; 360/32

(57) ABSTRACT

An apparatus for recording and reproducing information data, which comprises an operation control portion operative to perform such a control operation, when an external command is supplied to the control unit under a situation in which data reproducing portion is in operation to reproduce one of information data blocks from a first recording medium in the form of compressed data and data recording and reproducing portion is in operation to record recording information data obtained based on the reproduced information data block on a second recording medium and to reproduce the recording information data from the second recording medium in the form of the reproduced compressed data, as to cause the data recording and reproducing portion to cease its recording and reproducing operations, to cause the data reproducing portion to reproduce a newly selected information data block from the first recording medium in the form of the compressed data in accordance with the external command, and then to cause the data recording and reproducing portion to resume the recording and reproducing operations after the data reproducing portion has started reproducing the newly selected information data block from the first recording medium in the form of the compressed data.

### BACKGROUND OF THE INVENTION

1. Field of the Invention

The present invention relates generally to an apparatus for recording and reproducing information data, and more particularly, a recording and reproducing apparatus operative to reproduce information data from a first recording medium on which the information data are recorded, to record the information data reproduced from the first recording medium on a second recording medium, and to reproduce the information data from the second recording medium.

2. Description of the Prior Art

There has been proposed a digital recording and reproducing apparatus which is operative to record digital information data, such as music program data, on a recording medium, such as a magnetic disc or a magneto-optical disc, and to reproduce the digital information recorded on the recording medium, as an apparatus capable of executing easily recording and reproduction of various digital information data. In the meantime, a relatively small optical disc which is a recording medium supplied with a plurality of digital information data blocks, such as a plurality of music program data blocks each representing a piece of music, previously recorded thereon and so called “Compact Disc (CD)”, has been put to practical use in various fields.

Under such a situation, a combination of a CD driving apparatus operative to drive a CD attached thereto for reproducing each of digital information data blocks recorded thereon and the digital recording and reproducing apparatus as mentioned above is often utilized for reproducing each of digital information data blocks, for example, each of music program data blocks, recorded on the CD attached to the CD driving apparatus, then recording the digital information data block reproduced from the CD on a magnetic disc or a magneto-optical disc employed in the digital recording and reproducing apparatus, and reproducing the digital information data block from the magnetic disc or the magneto-optical disc.

As for the combination thus constituted, in the CD driving apparatus, it is usual that the music program data blocks recorded on the CD are successively reproduced in accordance with the sequence of recording positions of the music program data blocks on the CD, and accordingly in the digital recording and reproducing apparatus, the music program data blocks reproduced from the CD are successively recorded on and almost simultaneously reproduced from the magnetic disc or the magneto-optical disc in accordance with the sequence of reproductions from the CD.

When the music program data blocks reproduced successively from the CD in the CD driving apparatus are recorded on and almost simultaneously reproduced from the recording medium in the digital recording and reproducing apparatus, under a condition in which one of the music program data blocks reproduced from the CD is actually recorded on and almost simultaneously reproduced from the recording medium in the digital recording and reproducing apparatus, even if an user of the combination of the CD driving apparatus and the digital recording and reproducing apparatus intends to have a movement of program by which another music program data block is selected to be reproduced from the CD according to the user's preference in place of the music program data block actually put in reproduction from the CD at that time, such a movement of program is prohibited to be carried out.

The reason for this is that, if the movement of program is carried out under the condition in which one of the music program data blocks reproduced from the CD is actually recorded on and reproduced from the recording medium in the digital recording and reproducing apparatus, such an undesirable condition that the music program data block which has been continuously recorded on the recording medium is suddenly ceased to be supplied in the middle portion thereof and the middle to end portion of another music program data block which is newly selected is supplied to be recorded on the recording medium in succession to the music program data block recorded previously, is brought about in the digital recording and reproducing apparatus. This results in a disadvantage that a portion of the music program data blocks recorded on the CD between the middle portion of the music program data block previously recorded on the recording medium and the middle portion of the music program data block newly selected to be recorded on the recording medium is not recorded at all on the recording medium in the digital recording and reproducing apparatus.

In the situation that the movement of program is prohibited to be carried out as aforementioned when one of the music program data blocks reproduced from the CD is actually recorded on and reproduced from the recording medium in the digital recording and reproducing apparatus, the user of the combination of the CD driving apparatus and the digital recording and reproducing apparatus may be dissatisfied with the performance of the combination and feel inconvenience to the combination.

### OBJECTS AND SUMMARY OF THE INVENTION

Accordingly, it is an object of the present invention to provide an apparatus for recording and reproducing information data, which is operative to reproduce a plurality of information data blocks, such as a plurality of music program data blocks, successively from a first recording medium on which the information data blocks are previously recorded, such as a CD on which the music program data blocks are previously recorded, to record data obtained based on the reproduced information data blocks on a second recording medium, such as a magnetic disc or a magneto-optical disc, and to reproduce the data from the second recording medium, and then, which avoids the aforementioned disadvantages encountered with the prior art.

Another object of the present invention is to provide an apparatus for recording and reproducing information data, which is operative to reproduce a plurality of information data blocks, such as a plurality of music program data blocks, successively from a first recording medium on which the information data blocks are previously recorded, such as a CD on which the music program data blocks are previously recorded, to record data obtained based on the reproduced information data blocks on a second recording medium, such as a magnetic disc or a magneto-optical disc, and to reproduce the data from the second recording medium, and in which, when data obtained based on one of the information data blocks reproduced from the first recording medium are actually recorded on and reproduced from the second recording medium, it is possible to change a condition in which said one of the information data blocks is reproduced from the first recording medium into a different condition in which another information data block is reproduced from the first recording medium in place of said one of the information data blocks without any particular disadvantage or trouble.

A further object of the present invention is to provide an apparatus for recording and reproducing information data, which is operative to reproduce a plurality of information data blocks, such as a plurality of music program data blocks, successively from a first recording medium on which the information data blocks are previously recorded, such as a CD on which the music program data blocks are previously recorded, to record data obtained based on the reproduced information data blocks on a second recording medium, such as a magnetic disc or a magneto-optical disc, and to reproduce the data from the second recording medium, and in which, when data obtained based on one of the music program data blocks reproduced from the CD are actually recorded on and reproduced from the magnetic disc or the magneto-optical disc, a movement of program by which another music program data block is selected to be reproduced from the CD in place of the music program data block just put in reproduction from the CD at that time, can be carried out without any particular disadvantage or trouble.

According to the present invention, there is provided an apparatus for recording and reproducing information data, which comprises a data reproducing portion for reproducing in the form of compressed data formed substantially through data compression processing each of information data blocks from a first recording medium on which the information data blocks are previously recorded, an encoder for causing the compressed data obtained from the data reproducing portion to be subjected to encoding processing so as to produce recording information data, a recording buffer portion for holding the recording information data supplied from the encoder, a data recording and reproducing portion operative to record the recording information data held by the recording buffer portion on a second recording medium and to reproduce the recording information data from the second recording medium in the form of reproduced compressed data, a reproducing buffer portion for holding the reproduced compressed data supplied from the data recording and reproducing portion, a decoder for causing the reproduced compressed data held by the reproducing buffer portion to be subjected to decoding processing so as to produce reproduced information data in the form of expanded data formed substantially through data expansion processing, a digital to analog (D/A) convertor for causing the reproduced information data obtained from the decoder to be subjected to D/A conversion processing so as to produce an analog information signal, and a control unit operative to perform such a control operation, when an external command is supplied to the control unit under a situation in which the data reproducing portion is in operation to reproduce the information data block in the form of the compressed data and the data recording and reproducing portion is in operation to record the recording information data on the second recording medium and to reproduce the recording information data from the second recording medium in the form of the reproduced compressed data, as to cause the data recording and reproducing portion to cease its recording and reproducing operations, to cause the data reproducing portion to select one of the information data blocks recorded on the first recording medium and reproduce the information data block newly selected from the first recording medium in the form of the compressed data in accordance with the external command, and then to cause the data recording and reproducing portion to resume the recording and reproducing operations after the data reproducing portion has started reproducing the information data block newly selected from the first recording medium in the form of the compressed data.

In the apparatus for recording and reproducing information data thus constituted in accordance with the present invention, when the external command is supplied to the control unit under the situation in which the data reproducing portion is in operation to reproduce the information data block in the form of the compressed data and the data recording and reproducing portion is in operation to record the recording information data on the second recording medium and to reproduce the recording information data in the form of the reproduced compressed data from the second recording medium, the control unit performs the control operation according to the external command. With this control operation by the control unit, the data recording and reproducing portion is caused to cease its recording and reproducing operations, the data reproducing portion is caused to select one of the information data blocks recorded on the first recording medium and reproduce the information data block newly selected from the first recording medium in the form of compressed data in accordance with the external command, and then the data recording and reproducing portion is caused to resume the recording and reproducing operations after the data reproducing portion has started reproducing the information data block newly selected from the first recording medium in the form of the compressed data.

Consequently, when the compressed data obtained as the recording information data based on one of the information data blocks reproduced from the first recording medium are actually recorded on and reproduced from the second recording medium in the data recording and reproducing portion, a condition in which said one of the information data blocks is reproduced from the first recording medium can be changed into a different condition in which another information data block is reproduced from the first recording medium in place of said one of the information data blocks without any particular disadvantage or trouble. Further, with the apparatus for recording and reproducing information data thus constituted in accordance with the present invention, when the compressed data obtained based on one of the music program data blocks reproduced from the CD in the data reproducing portion are actually recorded on and reproduced from the magnetic disc or the magneto-optical disc in the data recording and reproducing portion, a movement of program by which another music program data block is selected to be reproduced from the CD in place of the music program data block just put in reproduction from the CD at that time, can be carried out without any particular disadvantage or trouble in the data reproducing portion.

The above, and other objects, features and advantages of the present invention will be become apparent from the following detailed description taken in conjunction with the accompanying drawings.

### BRIEF DESCRIPTION OF THE DRAWINGS

FIG. 1 is a schematic block diagram showing an embodiment of apparatus for recording and reproducing information data according to the present invention; and

FIG. 2 is a flow chart showing an example of an operational program for microcomputer used in a control unit employed in the embodiment shown in FIG. 1.

### DESCRIPTION OF THE PREFERRED EMBODIMENT

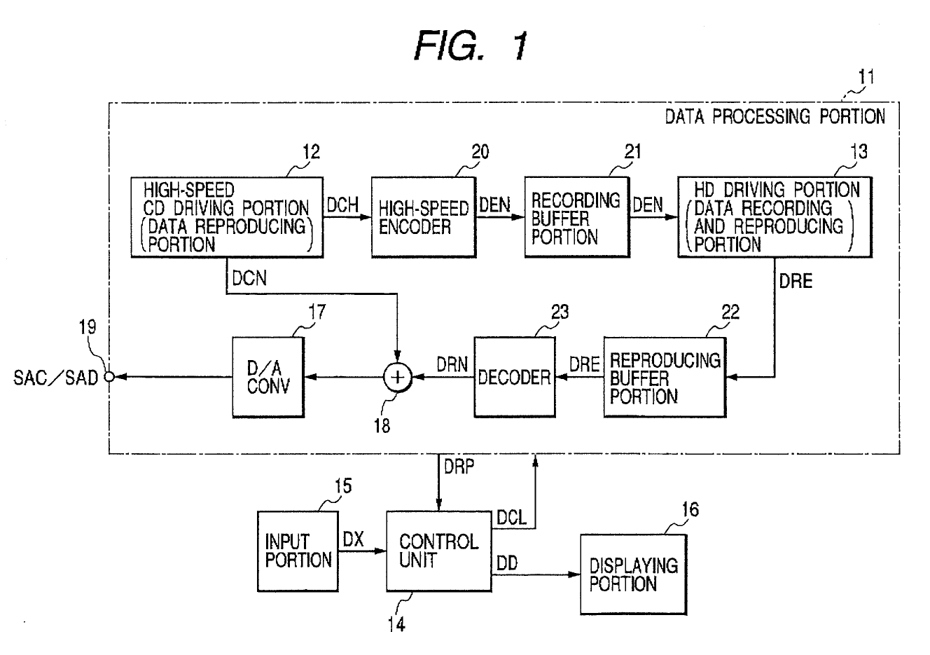

FIG. 1 shows schematically an embodiment of apparatus for recording and reproducing information data according to the present invention.

Referring to FIG. 1, in the embodiment, a data processing portion 11 is provided. In the data processing portion 11, a high-speed CD driving potion 12 and a hard disc (HD) driving portion 13 are contained.

When the high-speed CD driving potion 12 is put in operation, a CD, namely, a relatively small optical disc, on which a plurality of information data blocks, for example, a plurality of music program data blocks are previously recorded, is detachably attached to the high-speed CD driving potion 12. The high-speed CD driving potion 12 to which the CD is attached performs selectively a normal driving operation for driving the CD at a normal speed of revolution which is substantially the same as a recording speed of revolution at which the CD is driven so that the information data blocks recorded on the CD and a high-speed driving operation for driving the CD at a high speed of revolution which is, for example, ten times faster than the normal speed of revolution.

When the CD is driven at the normal speed of revolution, the high-speed CD driving portion 12 is operative to reproduce each of the information data blocks from the CD to obtain normal reproduced information data DCN. Further, when the CD is driven at the high speed of revolution, the high-speed CD driving portion 12 is operative to reproduce each of the information data blocks from the CD in the form of compressed data DCH which are formed substantially through data compression processing. The high-speed CD driving portion 12 thus operating with the CD constitutes a data reproducing portion.

The HD driving portion 13 contains as a recording medium an HD which is constituted with, for example, a magnetic disc or a magneto-optical disc. Then, the HD driving portion 13 is operative to record data supplied thereto on the HD, to reproduce data from the HD on which the data are recorded or to record data supplied thereto on the HD and almost simultaneously reproduce the data from the HD. The HD driving portion 13 thus operating with the HD constitutes a data recording and reproducing portion.

A control unit 14 is provided in relation to the data processing portion 11 containing the high-speed CD driving portion 12 and the HD driving portion 13. An input portion 15 is connected to the control unit 14.

The control unit 14 is supplied with input data DX which are obtained from the input portion 15 in response to, for example, manual operations on the input portion 15 and control information data DRP which are obtained from the data processing portion 11 and operative to produce control data DCL based on one or both of the input data DX and the control information data DRP and to supply the data processing unit 11 with the control data DCL. In the data processing portion 11 to which the control data DCL is supplied, various portions including the high-speed CD driving portion 12 and the HD driving portion 13 are controlled in operation with the control data DCL from the control unit 14. The control unit 14 constitutes an operation control portion for the data processing portion 11.

A displaying portion 16 is connected to the control unit 14. In the displaying portion 16, the state of supply of the input data DX to the control unit 14, the state of operation control to the data processing portion 11 by the control unit 14 and so on are displayed in response to displaying data DD which are supplied to the displaying portion 16 from the control unit 14.

With the structure described above, when the high-speed CD driving portion 12 drives the CD attached thereto at the normal speed of revolution and reproduces each of the information data blocks from the CD to obtain the normal reproduced information data DCN in response to the control data DCL supplied to the data processing portion 11 from the control unit 14, the normal reproduced information data DCN obtained from the high-speed CD driving portion 12 are supplied through a data adding portion 18 to a D/A convertor 17. The D/A convertor 17 is operative to cause the normal reproduced information data DCN to be subjected to D/A conversion so as to produce an analog information signal SAC, which may be a music program signal representing a piece of music, based on each of the information data blocks recorded on the CD.

The analog information signal SAC is transmitted from the D/A convertor 17 to an output terminal 19 of the data processing portion 11.

When the high-speed CD driving portion 12 drives the CD attached thereto at the high speed of revolution and reproduces each of the information data blocks from the CD to obtain the compressed data DCH in response to the control data DCL supplied to the data processing portion 11 from the control unit 14, the compressed data DCH obtained from the high-speed CD driving portion 12 are supplied to a high-speed encoder 20. The high-speed encoder 20 is operative to cause the compressed data DCH to be subjected to high-speed encoding processing so as to produce recording information data DEN based on the compressed data DCH. The recording information data DEN obtained from the high-speed encoder 20 are supplied to a recording buffer portion 21.

The recording buffer portion 21 holds the recording information data DEN for a necessary period to be supplied to the HD driving portion 13. The HD driving portion 13 records the recording information data DEN from the recording buffer portion 21 on the HD contained therein and almost simultaneously reproduces the recording information data DEN from the HD to obtain reproduced compress data DRE in response to the control data DCL supplied to the data processing portion 11 from the control unit 14.

The reproduced compressed data DRE thus obtained from the HD driving portion 13 are held by a reproducing buffer portion 22 for a necessary period and then supplied to a decoder 23. The decoder 23 is operative to the reproduced compressed data DRE from the reproducing buffer portion 22 to be subjected to decoding processing which includes data expansion processing so as to produce reproduced information data DRN based on the reproduced compressed data DRE.

The reproduced information data DRN obtained from the decoder 23 are supplied through the data adding portion 18 to the D/A convertor 17. The D/A convertor 17 is operative to cause the reproduced information data DRN to be subjected to D/A conversion so as to produce an analog information signal SAD, which may be a music program signal representing a piece of music, based on each of the information data blocks recorded on the CD. The analog information signal SAD is transmitted from the D/A convertor 17 to the output terminal 19 of the data processing portion 11. In such a condition, since the recording information data DEN recorded on and reproduced from the HD in the HD driving portion 13 are compressed data which are compressed in time compared with the reproduced information data DRN supplied to the D/A convertor 17, the recording and reproducing operations performed with the recording information data DEN in the HD driving portion 13 have finished before the transmission of the analog information signal SAD from the D/A convertor 17 to the output terminal 19 of the data processing portion 11 has just finished.

When each of the information data blocks are reproduced from the CD in the form of the compressed data DCH in the high-speed CD driving portion 12 and the recording information data DEN obtained from the recording buffer portion 21 based on the compressed data DCH are recorded on the HD in the HD driving portion 13 as described above, a recording position of the recording information data DEN on the HD is predetermined with reference to the information data block on the CD corresponding to the recording information data DEN in question.

In this connection, a table of contents (TOC) previously provided on the CD is read from the CD in the high-speed CD driving portion 12 prior to the recording on the HD of the recording information data DEN obtained from the recording buffer portion 21. Then, each recording position of the recording information data DEN which correspond to the information data block reproduced from the CD in the form of the compressed data DCH is previously allocated on the HD with reference to relative information of the information data blocks recorded on the CD contained in the TOC read from the CD in the high-speed CD driving portion 12.

In the case where a user of the embodiment shown in FIG. 1 intends to have a movement of program under a condition in which one of the information data blocks is reproduced from the CD in the high-speed CD driving portion 12 and the recording information data DEN are actually recorded on the HD and almost sImultaneously reproduced from the HD in the form of the reproduced compressed data DRE in the HD driving portion 13 in such a manner as described above, the input data DX which demand a specific condition in which a selected one of the information data blocks is reproduced from the CD in the form of the compressed data DCH in the high-speed CD driving portion 12 are supplied to the control unit 14 from the input portion 15.

The control unit 14 to which such an input data DX as mentioned above produces a specific control data DCL and puts the data processing portion 11 in operation control with the specific control data DCL.

In this control to the data processing portion 11, the control unit 14 is operative first to cause the HD driving portion 13 to cease its recording and reproducing operations for recording the recording information data DEN at the predetermined recording position on the HD and almost simultaneously reproducing the recording information data DEN from the predetermined recording position on the HD in the form of the reproduced compressed data DRE, next to store positional information representing the recording position on the CD of the information data block which had been reproduced from the CD up to that time in the high-speed CD driving portion 12 in a memory contained in the control unit 14, then to cause the high-speed CD driving portion 12 to select one of the information data blocks recorded on the first recording medium and reproduce the information data block newly selected in the form of compressed data in accordance with the external command, and further to cause the HD driving portion 13 to resume the recording and reproducing operations after the high-speed CD driving portion 12 has started reproducing the information data block newly selected from the CD in the form of the compressed data DCH. The HD driving portion 13 having resumed its recording and reproducing operations is operative to record the recording information data DEN corresponding to the information data block newly selected at the predetermined recording portion on the HD which is other than that at which the information data block had been recorded up to the suspension of the recording and reproducing operations in the HD driving portion 13.

After the high-speed CD driving portion 12 has finished the operation for reproducing the selected information data block from the CD in the form of the compressed data DCH, the control unit 14 is operative to detect a portion of the information data block and the whole information data blocks recorded on the CD which have not been reproduced from the CD in the high-speed CD driving portion 12 and to cause the high-speed CD driving portion 12 to reproduce the detected portion and blocks from the CD in the form of the compressed data DCH. Further, the control unit 14 is operative also to cause the HD driving portion 13 to record the recording information data DEN corresponding to the detected portion and blocks on the CD and obtained from the recording buffer portion 21 at that time at the predetermined recording position on the HD and almost simultaneously to reproduce the recording information data DEN from the predetermined recording position on the HD in the form of the reproduced compressed data DRE.

Since the recording information data DEN recorded on and reproduced from the HD in the HD driving portion 13 are compressed data which are compressed in time compared with the reproduced information data DRN supplied to the D/A convertor 17 and the recording and reproducing operations performed with the recording information data DEN in the HD driving portion 13 have finished before the transmission of the analog information signal SAD from the D/A convertor 17 to the output terminal 19 of the data processing portion 11 has just finished, as aforementioned, it is usual that the user of the embodiment shown in FIG. 1 who may enjoy sound reproduced based on the analog information signal SAD transmitted to the output terminal 19 of the data processing portion 11 does not become aware that a first condition in which one of the information data block is reproduced from the CD in the form of the compressed data DCH is changed into a second condition in which the selected information data block is reproduced from the CD in the form of the compressed data DCH is changed into a condition in which the selected and then the second condition is further changed in a third condition in which the portion of the information data block and the whole information data blocks recorded on the CD which have not been previously reproduced from the CD are reproduced from the CD in the form of the compressed data DCH in the high-speed CD driving portion 12.

Accordingly, in the embodiment shown in FIG. 1, when the recording information data DEN which are obtained as the compressed data based on one of the information data blocks reproduced from the CD in the high-speed CD driving portion 12 are actually recorded on the HD and almost simultaneously reproduced from the HD in the form of the reproduced compressed data DRE in the HD driving portion 13, a condition in which said one of the information data blocks is reproduced from the CD can be changed into a different condition in which the selected information data block is reproduced from the CD in place of said one of the information data blocks without any particular disadvantage or trouble. Consequently, when one of the information data blocks is reproduced from the CD in the form of the compressed data DCH in the high-speed CD driving portion 12 and the recording information data DEN obtained based on the compressed data DCH are actually recorded on and reproduced from the HD in the HD driving portion 13, the movement of program by which another information data block is selected to be reproduced from the CD in place of said one of the information data blocks, can be carried out without any particular disadvantage or trouble in the high-speed CD driving portion 12.

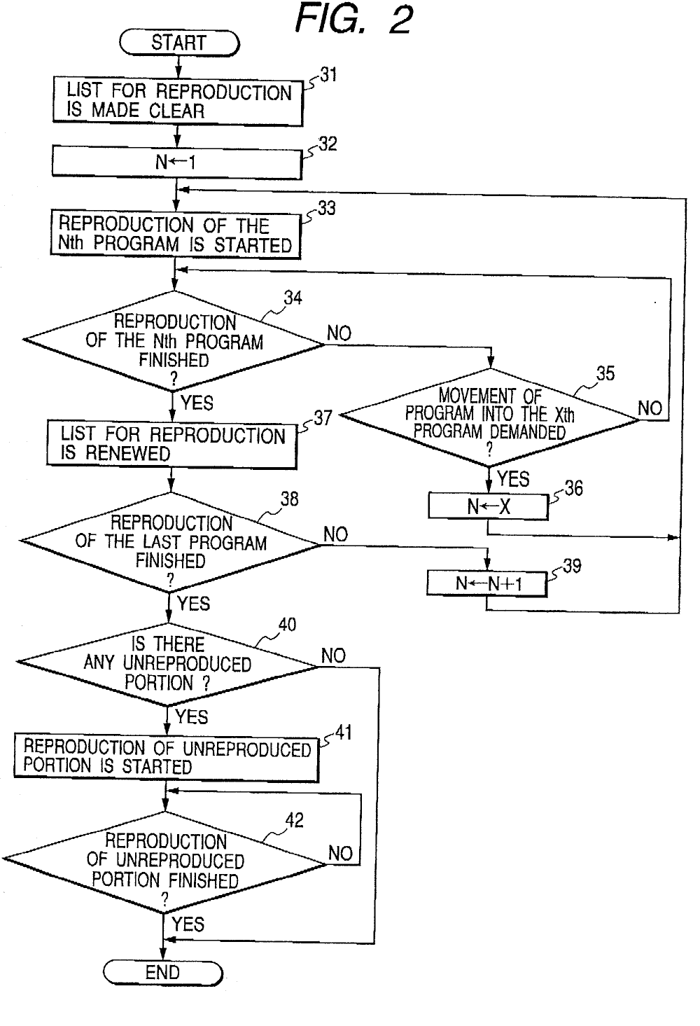

FIG. 2 shows a flow chart representing an example of a control program which the control unit 14 carries out for controlling the high-speed CD driving portion 12 to reproduce successively the information data blocks from the CD and controlling also the HD driving portion 13 to record the recording information data DEN on the HD and almost simultaneously to reproduce the recording information data DEN from the HD in the form of the reproduced compressed data DRE.

The example of the control program represented by the flow chart shown in FIG. 2 is carried out under a condition in which a plurality of music program data blocks are recorded as the information data blocks on the CD.

According to the flow chart shown in FIG. 2, after the start, in step 31, a list for reproduction is made clear, and in step 32, a variable N is set to be “1”.

Next, in step 33, the high-speed CD driving portion 12 is caused to start reproducing the music program data block representing the Nth program from the CD in the form of the compressed data DCH and the HD driving portion 13 is caused to record the recording information data DEN on the HD and almost simultaneously to reproduce the recording information data DEN from the HD in the form of the reproduced compressed data DRE. Then, in step 34, it is checked whether the reproduction of the music program data block representing the Nth program has finished in the high-speed CD driving portion 12 or not.

If it is clarified in the step 34 that the reproduction of the music program data block representing the Nth program has not finished, it is checked whether the input data DX which demand the specific condition in which the selected music program data block representing the Xth program is reproduced from the CD in the form of the compressed data DCH in the high-speed CD driving portion 12, that is, the input data DX which demand the movement of program into the Xth program, are supplied to the control unit 14 from the input portion 15 or not in step 35. If the input data DX which demand the movement of program into the Xth program are not supplied to the control unit 14 from the input portion 15, the process returns to the step 34.

To the contrary, if it is clarified in the step 35 that the input data DX which demand the movement of program into the Xth program are supplied to the control unit 14 from the input portion 15, the HD driving portion 13 is caused to cease its recording and reproducing operations for recording the recording information data DEN on the HD and almost simultaneously reproducing the recording information data DEN from the HD in the form of the reproduced compressed data DRE, the positional information representing the recording position on the CD of the music program data block which had been reproduced from the CD up to that time in the high-speed CD driving portion 12 is stored in the memory contained in the control unit 14, the variable N is set to be X, and information of X is also stored in the memory contained in the control unit 14, in step 36, and then the process returns to the step 33.

If it is clarified in the step 34 that the reproduction of the music program data block representing the Nth program has finished, the list for reproduction is renewed in step 37 and it is checked in step 38 whether the reproduction of the music program data block representing the last program has finished in the high-speed CD driving portion 12 or not. If the reproduction of the music program data block representing the last program has not finished, the variable N is increased by 1 in step 39. Then, the process returns to the step 33.

On the other hand, if it is clarified in the step 38 that the reproduction of the music program data block representing the last program has finished, it is checked in step 40 whether any unreproduced portion of the music program data blocks recorded on the CD, which has not been reproduced from the CD in the high-speed CD driving portion 12 remains or not. If it is clarified that the unreproduced portion of the music program data blocks remains, the high-speed CD driving portion 12 is caused to start reproducing the unreproduced portion of the music program data blocks from the CD in the form of the compressed data DCH and the HD driving portion 13 is caused to caused to record the recording information data DEN on the HD and almost simultaneously reproducing the recording information data DEN from the HD in the form of the reproduced compressed data DRE in step 41.

Then, in step 42, it is checked whether the reproduction of the unreproduced portion of the music program data blocks has finished in the high-speed CD driving portion 12 or not. If the reproduction of the unreproduced portion of the music program data blocks has not finished, the check in the step 42 is repeated. If the reproduction of the unreproduced portion of the music program data blocks has finished, the control program is terminated.

Further, if it is clarified in the step 40 that the unreproduced portion of the music program data blocks does not remain, the control program is terminated.

Although, in the embodiment shown in FIG. 1, the high-speed CD driving potion 12 is so constituted as to be provided with the CD on which the information data blocks, for example, the music program data blocks, are previously recorded and to drive the CD at the normal speed of revolution or the high speed of revolution for reproducing the information data blocks from the CD, it is possible for high-speed CD driving potion 12 to be so constituted as to be provided with a recording medium other than the CD, such as a digital videl disc (DVD) on which a plurality of video program data blocks are previously recorded, and to drive the recording medium other than the CD at a normal speed of revolution or a high speed of revolution for reproducing data from the recording medium other than the CD.

What is claimed is:

1. An apparatus for recording and reproducing information data comprising;
a data reproducing portion for reproducing in the form of compressed data formed substantially through data compression processing each of information data blocks from a first recording medium on which the information data blocks are previously recorded,
an encoding portion for causing the compressed data obtained from the data reproducing portion to be subjected to encoding processing so as to produce recording information data,
a recording buffer portion for holding the recording information data supplied from the encoding portion,
a data recording and reproducing portion operative to record the recording information data held by the recording buffer portion on a second recording medium and to reproduce the recording information data from the second recording medium in the form of reproduced compressed data,
a reproducing buffer portion for holding the reproduced compressed data supplied from the data recording and reproducing portion,
a decoding portion for causing the reproduced compressed data held by the reproducing buffer portion to be subjected to decoding processing so as to produce reproduced information data in the form of expanded data formed substantially through data expansion processing,
a digital to analog conversion portion for causing the reproduced information data obtained from the decoding portion to be subjected to digital to analog conversion processing so as to produce an analog information signal, and
an operation control portion operative to perform such a control operation, when an external command is supplied to the operation control portion under a situation in which the data reproducing portion is in operation to reproduce the information data block in the form of the compressed data and the data recording and reproducing portion is in operation to record the recording information data on the second recording medium and to reproduce the recording information data from the second recording medium in the form of the reproduced compressed data, as to cause the data recording and reproducing portion to cease its recording and reproducing operations, to cause the data reproducing portion to select one of the information data blocks recorded on the first recording medium and reproduce the information data block newly selected from the first recording medium in the form of the compressed data in accordance with the external command, and then to cause the data recording and reproducing portion to resume the recording and reproducing operations after the data reproducing portion has started reproducing the information data block newly selected from the first recording medium in the form of the compressed data.

2. An apparatus for recording and reproducing information data according to claim 1, wherein the data recording and reproducing portion is operative to record the recording information data held by the recording buffer portion at predetermined recording portions on the second recording medium, which are allocated on the second recording medium respectively with reference to the information data blocks reproduced from the first recording medium in the data reproducing portion.

3. An apparatus for recording and reproducing information data according to claim 1, wherein the operation control portion is operative to cause the data recording and reproducing portion, which resumes the recording and reproducing operations after the data reproducing portion has started reproducing the information data block newly selected from the first recording medium in the form of the compressed data, to record the recording information data held by the recording buffer portion at a predetermined recording portions on the second recording medium, which is selected with reference to the information data block newly selected.

4. An apparatus for recording and reproducing information data according to claim 1, wherein the data reproducing portion is operative also to reproduce each of the information data blocks from the first recording medium in the form of normal reproduced information data and to supply the digital to analog conversion portion with the normal reproduced information data.

5. An apparatus for recording and reproducing information data according to claim 1, wherein the first recording medium is constituted with an optical recording medium and the second recording medium is constituted with a magnetic or magneto-optical recording medium.

6. An apparatus for recording and reproducing information data according to claim 1, wherein the first recording medium is provided with a plurality of music program data blocks recorded thereon as the information data blocks.
